(19) United States
(12) Patent Application Publication
(10) Pub. No.: US 2003/0159329 A1
(43) Pub. Date: Aug. 28, 2003

(54) Pivoting jig head and hook combination

(76) Inventor: Allan David Mitchell, Sydney (AU)

Correspondence Address: STEPHEN CHRISTOPHER SWIFT, SWIFT LAW OFFICE, SUITE 600, 1800 DIAGONAL ROAD, ALEXANDRIA, VA, 22314-2840, US

(21) Appl. No.: 10/375,035

(22) Filed: Feb. 28, 2003

Related U.S. Application Data
(60) Provisional application No. 60/361,199, filed on Feb. 28, 2002.

(51) Int. Cl. A01K 85/00

(52) U.S. Cl. 43/42.37

(57) ABSTRACT

A pivoting jig head and hook combination for fishing. The combination functions as a action producing lure wherein the intimacy between the tail portion of the plastic lure body 104 and the rear portion of hook 101 stabilizes the position of the jig head 102 on the shank 105 along with forward motion of the combination as it is pulled through water. The pivot ability of the jig head provides additional action to the tail portion of the plastic lure body 104. The jig head maybe dynamically formed to produce a variety of side to side actions when pulled forward through the water. As the combination has two components the rattling or vibrations created during the combinations forward motion, this also develops a desirable sonic attraction.

This application is based on and claims priority from Provisional Patent Application No. 60/361,199 filed by the inventor Allan David Mitchell in the United States Patent & Trademark Office on Feb. 28, 2002

### BACKGROUND

In the art of fishing there are Jigs that are known in the art comprising essentially a lead or steel weighted jig. Commonly, the hook portion of the jig supports a soft plastic tube bait, live bait, a skirt or other attractive offering adapted to attract fish.

A problem with the prior art is that the jig head is fixed in unmovable fashion to the hook. This severely limits the swimming or undulating motion available to the attractor portion of the combination.

### DESCRIPTION OF THE INVENTION

What is disclosed herein is a jig head and hook combination that is fluid in that the jig is pivot able around the shank of the hook in the combination.

The combination comprises a hook 101 having a bend provided therein along the shank portion 105 thereof the bend adapted to support a jig head 102. Jig head 102 has an opening 103 provided there through adapted to allow the hook 101 to be inserted there through at the shank potion 105 such that the jig head 102 is resident on and pivot able around the hook shank 101.

In a preferred embodiment, a plastic lure body 104 is affixed to the rear portion of jig 102 by a fastening method such as snap-on, threading, stretch over, hooking to, or other known methods. The tail portion of the lure body 104 can be of a variety of configurations for attracting fish.

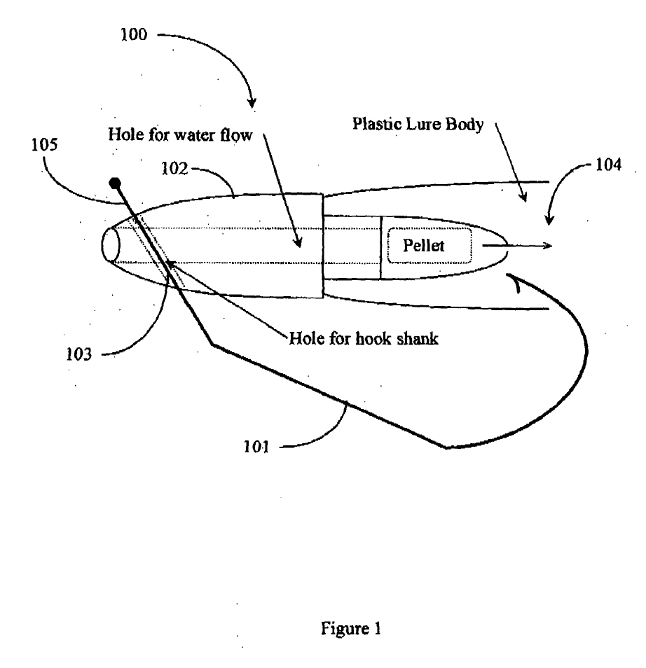

In one embodiment, a scent producing substance such as a fish attractant pellet labeled “pellet” in FIG. 1 is provided to be inserted into a cavity in the lure body 104 before it is affixed to the rear portion of sinker 102. In this case, a special opening labeled herein “Hole for water flow” is provided at the location of the rear of the “Pellet” in the lure body 104 to enable communication of the scent of the pellet to the water behind the lure body. Moreover, the jig head may be adapted with a cavity for holding a pellet or other attractant. In this embodiment, the cap portion has at least one small opening provided therein for enabling scent communication.

In another embodiment, there is no scent attractant used and no opening provided through the jig head. In this case, a live bait item, a foam bait item, or any other attractor may be used. A bead or split-shot then (not shown) may be applied to the hook shank 105 to keep the jig head 102 from ridding up the line. In one embodiment, a knot tied to the hook eye is sufficient for retaining the jig head 102 to the hook shank 105.

The claims defining the invention are as follows:

1. A Pivoting jig head and hook combination, comprising:
a hook, suitably bent to facilitate the positioning of an interchangeable jig head to enable motion around a hook shank.

2. The pivoting head jig head and hook combination according to claim 1, including a mechanism for connection of a bait or lure, and a barb that is an anchor point for the bait or lure.

3. The pivoting jig head and hook combination according to claim 1, wherein the jig head is suitably formed to enable a column of water to pass through it to accelerate scent or attractant dispersal.

4. The pivoting jig head and hook combination according to claim 1, wherein the jig head and hook in claim are separated to create a secondary sonic attraction.
